(19) United States
(12) Patent Application Publication
(10) Pub. No.: US 2004/0256193 A1
(43) Pub. Date: Dec. 23, 2004

(54) Multiplate clutch

(75) Inventor: Kiyokazu Ichikawa, Fukuroi-shi (JP)

Correspondence Address: CROWELL & MORING LLP, INTELLECTUAL PROPERTY GROUP, P.O. BOX 14300, WASHINGTON, DC, 20044-4300, US

(73) Assignee: NSK-Warner K.K., Shinagawa-ku (JP)

(21) Appl. No.: 10/868,841

(22) Filed: Jun. 17, 2004

(30) Foreign Application Priority Data
Jun. 18, 2003 (JP) 2003-172744

(51) Int. Cl. F16D 25/0638

(52) U.S. Cl. 192/85 AA

(57) ABSTRACT

A multiplate clutch is provided with a clutch case, friction plates and separator plates alternately arranged within the clutch case, and a piston arranged within the clutch case to apply a load on the friction plates and separator plates. At least one of bent portions with which a component of the multiplate clutch, for example, the clutch case is provided has an inner circumferential cross-sectional shape comprising at least two circular arc parts, preferably at least one straight-line part and at least two circular arc parts.

### FIELD OF THE INVENTION

This invention relates to a multiplate clutch useful in an automatic transmission or the like.

### DESCRIPTION OF THE BACKGROUND

FIG. 1 is a side cross-sectional view showing the basic construction of a multiplate clutch 10. The drawing shows a clutch case 20, a spline 21 formed on the clutch case 20, and bent portions 22, 23 of the clutch case 20. The drawing also depicts a piston 30, which in association with the clutch case 20, defines a piston-operating oil compartment 32. Also illustrated are a canceller 33, a stopper ring 34, and a return spring 34.

Designated at numeral 41 are separator plates, which are connected with the clutch case 20 through the splines 21 although the drawing shows only one of such splines. Friction plates 42 are arranged alternately with the separator plates 41, and are connected through splines with a hub (not shown) which is a counterpart member of transmission of rotations from the clutch case 20. The clutch case 20 is connected with a shaft 50 through splines 26 although only one of such splines is depicted in the drawing. Indicated at numeral 43 is a stopper ring against which the separator plates 41 and friction plates 42 are pressed.

Pressure oil is fed from an oilway 51 of the shaft 50 to the piston-operating oil compartment 32 through an oilway 24 of the clutch case 20, and presses the piston 30 rightwards as viewed in the drawing. By the pressing portion 31 formed at a free end of the piston 30, the separator plates 41 and friction plates 42 are, therefore, pressed against the stopper ring 43 so that the clutch is brought into engagement. An alternate long and short dash line X-X indicates a central axis of the shaft 50.

When the pressure oil is released from the piston-operating oil compartment 32, the piston returns leftwards owing to the arrangement of the return spring 35 so that the engagement of the clutch is cancelled. At this time, oil is allowed to enter under a centrifugal force between the piston 30 and the canceller 33 through an oilway 25 of the clutch case 20, and assists the action of the return spring 35.

FIG. 1 also illustrates sealing O-rings 36,37 and sealing members 52,53 disposed between the clutch case 20 and the shaft 50.

Upon engagement of the clutch, a large force is applied to each component. Large stresses concentrate especially on bent portions of individual components led by the bent portions 22,23 of the clutch case 20 as indicated by a circle A and a circle B, respectively, in FIG. 1. To prevent the components from breaking from the bent portions, it has been necessary to use high-strength materials or to form the components thick. In recent years, however, there is an ever increasing importance for weight reductions in equipment and savings in their fabrication costs. As a consequence, a need has also arisen on a multiplate clutch to disperse a stress, which would otherwise concentrate on each bent portion of each component, so that a maximum stress is reduced. As illustrated in FIG. 4, it was hence contemplated to form a plurality of small grooves on an inner wall of a bent portion 22 of a clutch case 20 such that a corrugated portion 70 is formed to disperse each stress, which would otherwise be applied to the bent portion 22, to reduce a maximum stress.

The formation of a corrugated portion as illustrated in FIG. 4 is, however, accompanied by an inconvenience in that that (1) when such small grooves are formed by cutting or the like, a longer machining time is required or (2) when such small grooves are formed by forging or aluminum die-casting, the metal is hardly allowed to flow into narrow areas such as the areas between the grooves so that a difficulty is encountered upon their formation.

### SUMMARY OF THE INVENTION

An object of the present invention is, therefore, to solve the above-described problems of the conventional art and to disperse a stress which is applied to a bent portion.

To achieve the above-described object, the present invention provides a multiplate clutch provided with a clutch case, friction plates and separator plates alternately arranged within the clutch case, and a piston arranged within the clutch case to apply a load on the friction plates and separator plates. At least one of bent portions with which a component of the multiplate clutch is provided has an inner circumferential cross-sectional shape comprising at least two circular arc parts. Preferably, the at least one of the bent portions with which the component of the multiplate clutch is provided can have an inner circumferential cross-sectional shape comprising at least one straight-line part and at least two circular arc parts.

Owing to the construction described above, the present invention makes it possible to reduce a maximum stress applied to a bent portion of a component, such as a clutch case, of a multiplate clutch so that the component can be formed thinner and/or the component can be made of a material of lower strength. The present invention, therefore, can achieve reductions in the weight and cost of a multiplate clutch.

### BRIEF DESCRIPTION OF THE DRAWINGS

FIG. 1 is a side cross-sectional view showing the fundamental construction of a multiplate clutch.

FIG. 2 is an enlarged view of portions indicated by a circle A in FIG. 1.

FIG. 3 is an enlarged view of portions indicated by a circle B in FIG. 1.

FIG. 4 is a view corresponding to FIG. 2, and illustrates a conventional example.

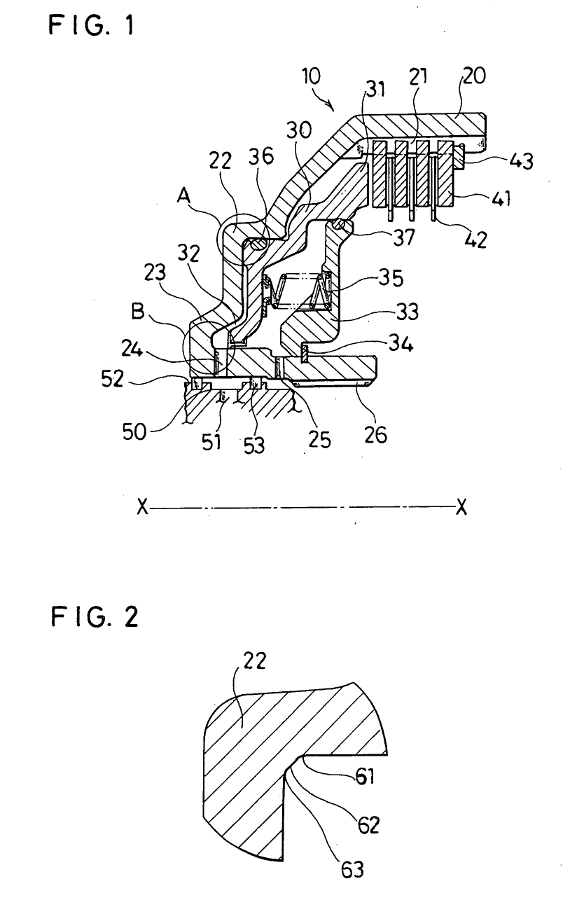

### DETAILED DESCRIPTION OF THE INVENTION

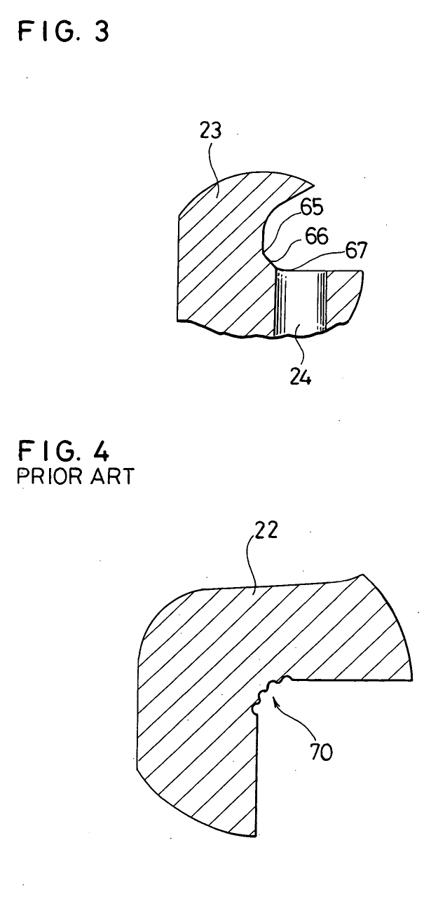

With reference to FIG. 2 and FIG. 3, a multiplate clutch 10 according to a preferred embodiment of the present invention will hereinafter be described. FIG. 2 and FIG. 3 respectively illustrate inner peripheral cross-sections of bent portions 22, 23 of a clutch case 20 in the multiplate clutch 10. In FIG. 2, the bent portion 22 includes a circular arc part 61 and circular arc part 63 on an inner circumference thereof. These circular arc part 61 and circular arc part 63 are connected together via a straight-line part 62. In FIG. 3, on the other hand, the bent portion 23 includes a circular arc part 65 and circular arc part 67 on an inner circumference thereof. These circular arc part 65 and circular arc part 67 are connected together via a straight-line part 66. Incidentally, numeral 24 indicates an oilway through which pressure oil is fed to a piston-operating oil compartment.

By forming the inner peripheral cross-sectional shapes of the bent portions of the clutch case 20 as illustrated in FIGS. 2 and 3, each stress applied to each bent portion can be dispersed substantially evenly without its localized concentration so that the value of a maximum stress can be reduced. As a result, the component can be formed thinner and/or can be made of a material of lower strength. It is, therefore, possible to provide a multiplate clutch reduced in both weight and production cost.

The preferred embodiment of the present invention has been described above by taking the clutch case as an example. It is, however, to be noted that the present invention can be applied not only to necessary one or ones of bent portions in such a clutch case but also to necessary one or ones of bent portions in other clutch components.

This application claims the priority of Japanese Patent Application 2003-172744 filed Jun. 18, 2003, which is incorporated herein by reference.

1. A multiplate clutch provided with a clutch case, friction plates and separator plates alternately arranged within said clutch case, and a piston arranged within said clutch case to apply a load on said friction plates and separator plates, wherein at least one of bent portions with which a component of said multiplate clutch is provided has an inner circumferential cross-sectional shape comprising at least two circular arc parts.

2. A multiplate clutch according to claim 1, wherein said at least one of said bent portions with which said component of said multiplate clutch is provided has an inner circumferential cross-sectional shape comprising at least one straight-line part and at least two circular arc parts.

3. A multiplate clutch according to claim 2, wherein said at least two circular arc parts are connected together via said at least one straight-line part.

4. A multiplate clutch according to claim 1, wherein said component provided with said bent portions is said clutch case which defines a piston-operating oil compartment.
